(19) United States
(12) Patent Application Publication
(10) Pub. No.: US 2026/0370106 A1
(43) Pub. Date: Nov. 19, 2026

(54) RESIN SYSTEM AND METHOD OF IMPREGNATING, STRENGTHENING OR ELECTRICALLY INSULATING A BODY BEARING WINDING

(71) Applicant: Innomotics GmbH, Nümberg (DE)

(72) Inventors: DIETER HEINL, Weisendorf (DE); TOBIAS KATZENBERGER, Bad Königshofen STT Unteressfeld (DE); BASTIAN PLOCHMANN, Neustadt an der Aisch (DE)

(73) Assignee: Innomotics GmbH, Nümberg (DE)

(21) Appl. No.: 19/515,327

(22) PCT Filed: Aug. 14, 2024
(86) PCT No.: PCT/EP2024/072852

§ 371 Date: Feb. 27, 2026

(30) Foreign Application Priority Data
Aug. 29, 2023 (EP) 23194037.0

(51) Int. Cl. H02K 15/122

(52) U.S. Cl. CPC H02K 15/122

(57) ABSTRACT

The present invention relates to a resin system, wherein the resin system is in the form of a two-component system and comprises a resin as a first component and a curing agent as a second component for the purposes of curing the resin, and the first component and the second component are coordinated with one another as follows: —the parts-by-volume mixing ratio is 3 parts resin to 1 part curing agent up to 1 part resin to 3 parts curing agent; and—the ratio of the viscosities of the first component and the second component lies in a range from 1 to 5 up to 5 to 1.

The Invention relates to a resin system comprising a resin and a curing agent. The invention further relates to the use of such a resin system in a method of impregnating, strengthening or electrically insulating a body bearing windings, and to a method of impregnating, strengthening or electrically insulating a body bearing windings.

Low-voltage motors are impregnated in the course of the manufacturing process with a liquid resin, which is then usually cured thermally over a certain period of time, thus resulting in a thermoset moulding material and effective electrical insulation (ICE) and mechanical strengthening of the winding.

EP 3 872 962 A1 relates to a method of impregnating, strengthening or electrically insulating a single- or multi-layer body bearing windings, in particular for an electrical machine, wherein the body bearing the windings is immersed into a multi-component resin system or is trickled with the multi-component resin system or is sprayed with the multi-component resin system. This document also relates to an electrical machine, in particular a motor, generator or transformer, impregnated, solidified or electrically insulated by such a method, and to the use of a multi-component resin system for impregnating, strengthening or electrically insulating an electrical machine.

However, solutions known from the prior art still have further potential for improvement, especially with regard to the best possible processibility of a resin system for impregnating, strengthening or electrically insulating a body bearing windings.

It is the object of the present invention to at least partly overcome the disadvantages known from the prior art. In particular, it is the object of the present invention to provide a solution by which good processibility of a resin system for impregnating, strengthening or electrically insulating a body bearing windings can be enabled.

The object is achieved in accordance with the invention at least in part by a resin system having the features of claim 1. The object is also achieved in accordance with the invention at least in part by a process having the features of claim 7 and by a use having the features of claim 10. Preferred embodiments of the invention are described in the dependent claims, in the description or in the figures, where further features described or disclosed in the dependent claims or in the description or the figures may represent subject matter of the invention individually or in any desired combination, unless the contrary is clearly apparent from the context.

Described is a resin system, wherein the resin system is designed as a two-component system and comprises a resin as a first component and a curing agent for curing the resin as a second component, wherein the first component and the second component are coordinated with one another as follows:
the parts-by-volume mixing ratio is 3 parts resin to 1 part curing agent up to 1 part resin to 3 parts curing agent; and
the ratio of the viscosities of the resin and curing agent is in a range from 1 to 5 up to 5 to 1.

Such a resin system has clear advantages over solutions from the prior art, in particular in the case of use in a method of impregnating, strengthening or electrically insulating a single- or multi-layer body bearing windings. Such a method shall be considered in particular to be one for treating a body bearing single- or multi-layer windings. The body is advantageously an electric motor or generator or a transformer. The body advantageously has a rotor and a stator.

The resin system described herein is configured as a two-component system. It thus comprises two different components, which are particularly advantageously coordinated with one another as described hereinafter.

The resin system comprises a resin as a first component. As a second component, the resin system comprises a curing agent for curing the resin. The resin and curing agent are coordinated with one another in such a way that curing of the resin can be conducted in a suitable manner. Such an adjustment of the type of curing agent to the type of resin is possible in principle for the skilled person without difficulty.

The first component and the second component, i.e. the resin and the curing agent, in addition to purely chemical compatibility are coordinated with one another as follows.

The parts-by-volume mixing ratio is 3 parts resin to1 part curing agent up to 1 part resin to 3 parts curing agent. Preferably, the parts-by-volume mixing ratio is 1.5 parts resin to1 part curing agent up to 1 part resin to 1.5 parts curing agent. For example, the parts-by-volume mixing ratio is 1 part resin to1 part curing agent.

Further, the ratio of the viscosities of the first component and the second component, i.e. of the resin and the curing agent, is within a range from 1 to 5 up to 5 to 1. Preferably, the ratio of the viscosities of the first component and the second component may be within a range from 1 to 2 up to 2 to 1. For example, the ratio of the viscosities of the first component and the second component may be in a range of 1 to 1. This viscosity describes an initial viscosity at 25 °C, where the relative viscosity ratio remains the same irrespective of the temperature and the test method. In principle, however, the viscosity is determinable according to DIN EN ISO 2431:2011.

It has been shown in a surprising manner that the above-described coordination of resin and curing agent can allow particularly advantageous properties. In particular, the above-described adjustment of the parts-by-volume mixing ratio and the ratio of the viscosities of the first and second component, i.e. of resin and curing agent, can allow a particularly advantageous use, in particular in a method of impregnating, strengthening or electrically insulating a single- or multi-layer body bearing windings, such as a component of an electric machine or of an electric motor.

Exact adjustment of the above-described parameters means that it is unnecessary to increase the temperature during the trickling process and subsequently during the gelating and curing operation in order to obtain a reasonable production time. In addition, inexpensive static mixing pipes are usable, which means that the individual components can be mixed in situ and no manual cleaning or plant downtime is required.

According to the invention, the processes described are thus implementable without difficulty, even with use of simple and inexpensive plant technology, also giving rise to high-quality products.

In particular, inadequate slot filling with the resin owing to excessively high viscosity and/or reactivity can be prevented or at least distinctly reduced. There is thus no need for a tilted position of the component to be impregnated, for instance of the rolling stator, which is often necessary in this regard in the prior art, and in that respect comparatively costly system concepts can thus be dispensed with.

The chemical resin components used and the respective manufacturing methods are closely coordinatable with one another and with the product requirement, such as the requirements on the component to be impregnated, for example the motor or motor component. Particular mention should be made here of process-critical parameters such as reactivity, i.e. the time until gelation at a certain temperature, volume shrinkage during curing, and the release of volatile components, such as reactive diluents, e.g. styrene. Additionally, the parameters after curing, such as mechanical and electrical strength, dielectric properties, glass transition temperature and thermal stability, are of relevance and are easily adjustable for the skilled person within the scope of the invention.

It is further conceivable that impregnation, strengthening or electrical insulation in the context of the present invention is accomplished using a 3K (3-component) resin system. Thixotropic additives, preferably with time-delayed action, can accelerate a viscosity-increasing effect with regard to gelation. This results in an increase in manufacturing efficiency, especially in terms of cycle time.

It may also be preferable that the resin system is a room temperature curing system. This means that the method is executable in a particularly simple and inexpensive manner. It is thus possible in this configuration to avoid compensating for insufficient reactivity by an increase in temperature of the body to be treated either before, during or after the treatment, for instance the trickling operation, which would on the one hand increase plant investment, for instance by the need to provide a Inductor or hot air furnace, and on the other hand increase costs by virtue of the energy needed. A room temperature curing system means one that cures at 22 °C.

With regard to the resin, it may be further preferable that the resin is selected from an epoxy resin, a silicone rubber, a polyurethane and a polyester. It has been found that the resin system has good implementability in the process described, especially when using such resins. Specific examples include epoxy resins or bisphenol F-epichlorohydrin resins.

The curing agent should be adapted to the resin in terms of its curing mechanism. More preferably, an amine curing agent may be used here, or it may be advantageous that the curing agent comprises an amine curing agent such as 2,4,6-tri (dimethylaminomethyl) phenol. An amine-based curing agent has the advantage that the curing can take place at room temperature, and so a form of curing also known as cold curing is possible. Epoxy resin is advantageous owing to its marked mechanical properties and only results in a small change in volume during curing. Epoxy resin advantageously does not include any solvents and has VOCs <1% by weight (volatile organic compounds, VOCs for short), i.e. less than 1% by weight of the entire material evaporates in the course of the curing process.

With regard to further technical features and advantages of the resin system, reference is made to the description of the method, the use, the examples and the figures.

Also described is a method of impregnating, strengthening or electrically insulating a body bearing single-layer or multi-layer windings, wherein the body bearing windings is immersed in a multicomponent resin system or is trickled with the multicomponent resin system or sprayed with the multicomponent resin system, wherein the resin system is one as described above.

The advantages that thus arise are in particular those described above with regard to the resin system arise. In particular, the coordinating of the described parameters allows use of a simple and inexpensive plant technology which comprises passive mixers, for instance, where a high-quality outcome is nevertheless possible.

In an advantageous embodiment of the invention, the body bearing the windings is immersed into the multicomponent resin system at room temperature or trickled with the multicomponent resin system or sprayed with the multicomponent resin system. As indicated above, this allows a particularly inexpensive and low-cost system technology which is also inexpensive operable.

For example, it may be advantageous that the body bearing the windings is immersed in the multi-component resin system or trickled with the multi-component resin system or sprayed with the multi-component resin system at an ambient temperature of 15 to 25 °C, in particular 20 to 23 °C.

In a further advantageous embodiment of the invention, the body bearing the windings is preheated to a temperature of 30 to 80 °C, in particular 30 to 60 °C. Preferably, the body bearing the windings is preheated inductively to a temperature of 30 to 80 °C, in particular 30 to 60 °C. This has the advantage that different ambient temperatures, for example in summer or winter, have no effect on the impregnating, strengthening or electrical insulation. The body bearing the windings has, for example, a defined temperature independent of the ambient temperature at the start of the method of impregnation, strengthening or electrical insulation, and then cools down.

The invention offers the further advantage that further work, such as mounting of an end plate, which is only possible at room temperature owing to coefficients of thermal expansion, can be carried out promptly after impregnation. No active cooling is needed. In addition, there is no need to accept a delay with utilization of storage space owing to a cooling time at room temperature. Cost-and time-efficient production is thus possible.

In addition, there is no need for the high energy consumption mentioned at the outset for heating of the winding with currents of, for example, more than 500 A. In order to control these currents, very complex power electronics are also required in a manufacturing plant. This is also dispensed with by the invention.

The invention also offers the advantage that there is no need to provide areas in a manufacturing hall on which the impregnated bodies often cool down and cure, often over several days or even weeks. This has positive economic effects.

In a further advantageous embodiment, the body rotates about an axis when the body is immersed into a multi-component resin system or is being trickled with the multi-component resin system or sprayed with the multi-component resin system. For this purpose, the body is advantageously present on a roller station.

It may also be advantageous that the first component and the second component are conveyed separately from one another, where the first component and the second component are mixed immediately before the immersion or before the trickling or before the spraying to give the multi-component resin system. What is meant by “directly” is preferably a maximum period of 10 min.

An advantageous feature in the mixing of the first and second component is in particular the described ratio of the viscosities and the parts-by-volume ratios. This also allows for a static mixer in a particularly advantageous manner. It is accordingly advantageous that the first component and the second component are mixed together in a static mixer.

The rotation of the body prevents the resin system dripping off, especially the resin. The resin is drawn into the slots by capillary forces and gelates there within a few minutes. A drip-free condition should be achieved after no more than 20 min. The body can be removed from the rolling station and processed further without having to cure and/or cool down for a long time.

With regard to further technical features and advantages of the method, reference is made to the description of the resin system, the use, the examples and the figures.

The invention further relates to the use of a resin system as described above for impregnating, strengthening or electrically insulating a body bearing windings.

With regard to further technical features and advantages of the use, reference is made to the description of the resin system, the use, the examples and the figures.

Further details, features and advantages of the subject-matter of the invention will be apparent from the dependent claims and from the description of the figures that follows. The figures show in:

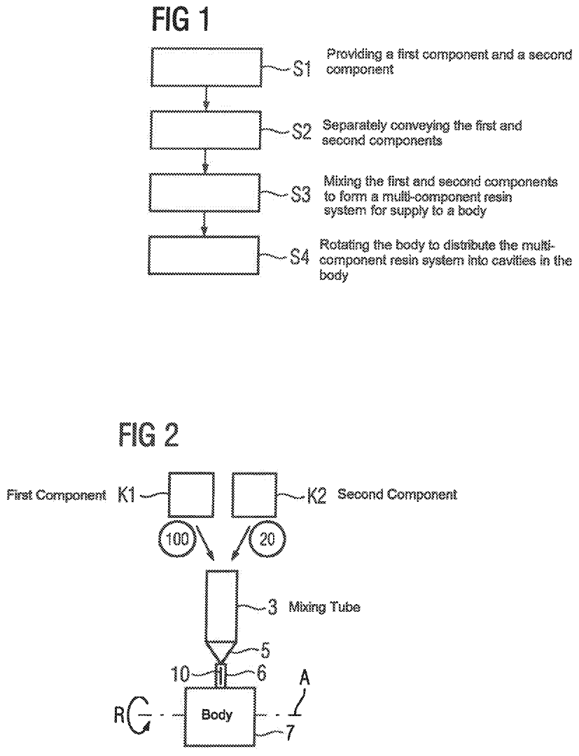

FIG. 1: the impregnation method, method; and

FIG. 2: an illustrative system for implementing the impregnation method; and

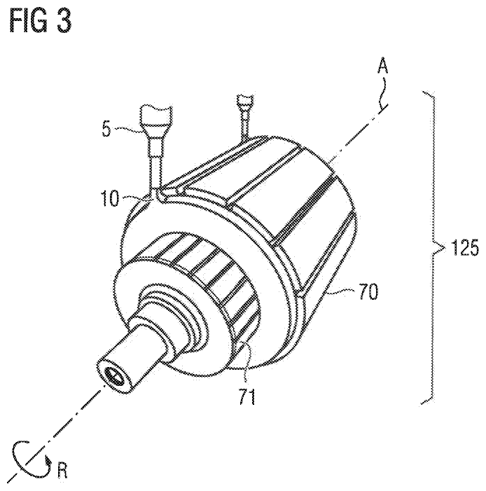

FIG. 3: a dynamo-electric rotary machine during the impregnation method.

FIG. 1 shows the impregnation method. In a first method step, a first component K1 and a second component K2 are provided. The first component K1 is a resin, the second component K2 is a curing agent. The two components are conveyed separately in a method step S2. In a method step S3, the two components are mixed to form a multi-component resin system 10, in this case a two-component resin system, and, preferably immediately after the mixing, applied to a body 7 or Introduced into the body.

More than two components are also possible.

In a method step S4, the rotation of the body 7 distributes the multi-component resin system 10 into cavities in the body 7. For example, if the body 7 is a stator, the multi-component resin system 10 is distributed in the slots.

FIG. 2 shows an illustrative system for implementing the impregnation method.

The first component K1 and the second component K2 are mixed in a mixing tube 3 to give the multi-component resin system 10 and discharged as a jet 6 through a nozzle 5 onto the body 7. The body rotates in the direction of rotation R about an axis A. The mixing tube is preferably a static mixer.

The trickle system from FIG. 2 thus comprises two separate conveying and dosing systems 20, 100 that contain the two components, i.e. resin and curing agent. The mixing of the two components is to take place in a technically advantageous design via a commercial static mixing tube 3, which, owing to its meandering flow path arrangement, ensures vortexing and hence homogeneous mixing of the two volume flows in situ, i.e. while they are flowing through. The static mixing tube 3 itself here Is, for example, an inexpensive disposable product which can be easily replaced after periods of operation and maintenance of the system, provided that the reactive mixture present therein is already gelated or partly cured and hence an intermediate flush with trickle resin for quick cleaning of the system is no longer possible.

FIG. 3 shows a dynamo-electric rotary machine 12 during the impregnation method. The figure shows a stator 70 and a rotor 71 of an electric machine. Through the nozzle 5, the multi-component resin system 10 in the figure hits the stator 70 while the stator 70 is rotating in the direction of rotation R about the axis A.

During further manufacturing steps, rotor 71 and/or stator 72 usually are exposed to elevated temperatures. For example, it follows a winding temperature of about 80 °C at the shrink-fitting of the aluminium housing at 200 °C, and a short-circuit test as a final test with freely selectable heating of the winding. Virtually 100% curing of the resin system, if chemically possible at all, is ensured before completion.

Without subsequent thermal processes, the curing of the resin system Is complete within a few days. There is no disruption of a manufacturing flow, since the product is drip-free after just a few minutes and has only minor surface stickiness, if any.

It has been shown in a surprising manner that, in particular, the inventive coordination of first and second components to one another offers particular benefits here, in that they are able to ensure, for example, sufficient miscibility even via a static system.

This will be explained in detail in the discussion of the examples.

### EXAMPLES

According to the invention, the following requirements are directed to the components of the method.
The viscosities of the individual components preferably do not exceed the value of 5000 mPas each at room temperature;
The parts-by-volume mixing ratio is 3 parts resin to 1 part curing agent up to 1 part resin to 3 parts curing agent, wherein 1:1 would be technically particularly preferable.
the ratio of the viscosities of the resin and curing agent is in a range from 1 to 5 up to 5 to 1, wherein 1:1 would again be particularly preferable.

The results found were as follows:

Table 1 firstly shows different combinations of resin and curing agent, and hence of first and second components.

TABLE 1

Reactivity

| Viscosity | unsuitable | suitable |
|---|---|---|
| unsuitable | HTV | LSR |
| suitable | EP / anhydride | EP / amine |
| | | RTV-1 |
| | | RTV-2 |
| | | PUR |
| | | UP |

Table 2 further shows the reactivity of the resin/curing agent mixture at corresponding initial viscosities of the mixture of resin and curing agent and at different axis lengths of the body to be treated, where axis lengths (AL) relate to the respective bodies.

TABLE 2

| | Axis lengths | | | | | |
|---|---|---|---|---|---|---|
| | up to | up to | up to | up to | up to | up to |
| Viscosity | AL50 | AL100 | AL250 | AL500 | AL750 | AL900 |
| Initial viscosity | <3000 | <2000 | <2000 | <1000 | <1000 | <700 |
| | mPas | mPas | mPas | mPas | mPas | mPas |
| Reactivity | after | after | after | after | after | after |
| (10 times initial | 1 h | 2 h | 3 h | 4 h | 8 h | 10 h |
| viscosity) | | | | | | |

The abbreviations given in Tables 1 and 2 should be understood as follows:
EP/amine: amine-cured epoxy resin formulation
EP/anhydride: anhydride-cured epoxy resin formulation
RTV-1:1-component room temperature crosslinking silicone rubbers (condensation-crosslinking)
RTV-2:2-component room temperature crosslinking silicone rubbers (addition- and condensation-crosslinking)
LSR: liquid silicone rubber (platinum crosslinking)
HTV: solid silicone rubber (addition- and condensation-crosslinking)
PUR: polyurethanes as reaction products of commercially available diisocyanates and the low-viscosity prepolymers and polyether/polyester polyols thereof
UP: unsaturated polyester as condensation products of commercially available diols (e.g.: ethylene glycol, butane-1,3-diol) and dicarboxylic acids/anhydrides (e.g.: phthalic anhydride, maleic anhydride) dissolved in vinyl monomers, accelerated and peroxidically cured.

Clear advantages are apparent over prior art resin systems, as shown in Table 3, which shows processibility in different configurations of the resin system in each case. This particularly includes the miscibility of resin and curing agent, which brings about significant advantages in application-specific terms.

TABLE 3

| | Parts-to-volume | Ratio of | |
|---|---|---|---|
| | ratio | viscosities | |
| No. | [K1 to K2] | [K1 to K2] | Processibility |
| 1 | 1/1 | 1/1 | ++ |
| 2 | 1/3 | 1/1 | ++ |
| 3 | 3/1 | 1/1 | ++ |
| 4 | 1/1 | 1/5 | ++ |
| 5 | 1/1 | 5/1 | ++ |
| 6 | 1/5 | 1/1 | + |
| 7 | 5/1 | 1/1 | + |
| 8 | 1/1 | 1/7 | + |
| 9 | 1/1 | 7/1 | + |

It has thus been shown that an inventive coordination of resin and curing agent can enable clear advantages in handling in a method of impregnating, strengthening or electrically insulating a body bearing single- or multi-layer windings.

Regardless of the grammatical gender of any particular term, individuals with male, female or different gender identity are encompassed.

Although the invention has been illustrated and described in detail by the preferred working examples, the invention is not restricted by the disclosed examples, and other variations can be derived therefrom by the skilled person without leaving the scope of the invention.

### LIST OF REFERENCE SIGNS

3 mixing tube
5 nozzle
6 jet
7 securing structure
10 resin system
20 conveying and metering system
70 stator
71 rotor
100 conveying and metering system
125 rotating machine
A axis
K1 component 1
K2 component 2
R direction of rotation
S1 method step
S2 method step
S3 method step
S4 method step

1. Resin system (10), wherein the resin system is designed as a two-component system and comprises a resin as a first component (K1) and a curing agent for curing the resin as a second component (K2), wherein the first component (K1) and the second component (K2) are coordinated with one another as follows:
the parts-by-volume mixing ratio is 3 parts resin to1 part curing agent up to 1 part resin to 3 parts curing agent; and
the ratio of the viscosities of the resin and the curing agent is in a range from 1 to 5 up to 5 to 1.

2. Resin system (10) according to claim 1, characterized in that the parts-by-volume mixing ratio is 1.5 parts resin to 1 part curing agent up to 1 part resin to 1.5 parts curing agent.

3. Resin system (10) according to claim 1 or 2, characterized in that the ratio of the viscosities of the resin and the curing agent is in a range from 1 to 2 up to 2 to 1.

4. Resin system (10) according to one of the claims 1 to 3, characterized in that the resin system (10) is a room temperature-curing system.

5. Resin system (10) according to one of the claims 1 to 4, characterized in that the resin is selected from an epoxy resin, a silicone rubber, a polyurethane and a polyester.

6. Resin system (10) according to one of the claims 1 to 5, characterized in that the curing agent comprises an amine curing agent.

7. Method of impregnating, strengthening or electrically insulating a body bearing single-layer or multi-layer windings, wherein the body bearing windings is immersed in a multicomponent resin system (10) or is trickled with the multicomponent resin system (10) or sprayed with the multicomponent resin system (10), characterized in that the resin system (10) is a system according to one of the claims 1 to 6.

8. Method according to claim 7, characterized in that the first component (K1) and the second component (K2) are mixed together in a static mixer.

9. Method according to one of the claim 7 or 8, characterized in that the body bearing windings is part of an electrical machine.

10. Use of a resin system (10) according to one of the claims 1 to 6 for impregnating, strengthening or electrically insulating a body bearing winding.
